(19) United States
(12) Patent Application Publication
(10) Pub. No.: US 2025/0362273 A1
(43) Pub. Date: Nov. 27, 2025

(54) COMBINING MULTIPLE ULTRASONIC BEAM SKEWS

(71) Applicant: Evident Canada, Inc., Québec (CA)

(72) Inventor: Tommy Bourgelas, Shannon (CA)

(21) Appl. No.: 18/867,241

(22) PCT Filed: May 10, 2023
(86) PCT No.: PCT/CA2023/050638

§ 371 Date: Nov. 19, 2024

Related U.S. Application Data
(60) Provisional application No. 63/365,047, filed on May 20, 2022.

(51) Int. Cl. G01N 29/26; G01N 29/06; G01S 7/52; G01S 15/89

(52) U.S. Cl. CPC G01N 29/262; G01N 29/0645; G01S 7/52028; G01S 7/5205; G01S 15/8911

(57) ABSTRACT

Techniques for ultrasonic inspection with different beam skews arranged in a group are described. For example, the techniques described herein can group a plurality of different beam skews in a single group as part of the same channel, leading to simpler handling and calibration. The techniques also describe a new scan image showing the different beam skews together so that the analyst can select and switch between the different beam skews easily.

### CLAIM OF PRIORITY

This patent application claims the benefit of priority U.S. Provisional Patent Application Ser. No. 63/365,047, titled “METHOD FOR COMBINING MULTIPLE PHASED ARRAY ULTRASONIC BEAM SKEW FOCAL LAWS INTO A SINGLE GROUP,” filed on May 20, 2022, which is hereby incorporated by reference herein in its entirety

### TECHNICAL FIELD

This application relates to ultrasonic inspection.

### BACKGROUND

Phased array ultrasonic testing (PAUT) is an advanced nondestructive examination technique that utilizes a set of ultrasonic testing (UT) probes made up of numerous small elements, each of which is pulsed individually with computer-calculated timing, and can be used to inspect more complex geometries that are difficult and much slower to inspect with single probes. PAUT can be used to inspect almost any material where traditional UT methods have been utilized, such as weld inspection, crack detection, and corrosion monitoring, and may be used across a wide range of industries including aerospace, power generation, petrochemical, metal billet and tubular goods suppliers, pipeline construction and maintenance, structural metals, and general manufacturing.

Compared to other forms of UT, PAUT has several advantages: (i) PAUT can be conducted more quickly than other forms of UT; (ii) it can easily be used for repeat scans because it has a high degree of repeatability; (iii) by emitting beams of different angles sequentially, PAUT is able to create detailed and accurate cross-sections of a part; and (iv) it is also particularly useful in situations where there is less room for mechanical scanning because PAUT inspection is able to sweep the beam without moving the probe.

### SUMMARY

Examples described herein relate to methods, systems, and a computer program product for ultrasonic inspection with different beam skews. Examples include: receiving scan control parameters including beam skew configuration for a plurality of beam skews arranged in a group; performing calibration for a for a respective beam skew the plurality of beam skews; establishing calibration values for at least one other beam skew of the plurality of beam skews based on the calibration performed for the respective beam skew; receiving data indicative of electrical response signals elicited by scanning the object, the scanning based on the scan control parameters; and generating data for a presentation based on the data indicative of electrical response signals corresponding to the plurality of beam skews in a channel.

### BRIEF DESCRIPTION OF THE DRAWINGS

The subject matter herein may be better understood by referring to the following description in conjunction with the accompanying drawings. The drawings are not meant to limit the scope of the claims included herewith. For clarity, not every element may be labeled in every figure. The drawings are not necessarily to scale, emphasis instead being placed upon illustrating embodiments, principles, and concepts. Thus, features and advantages of the present disclosure will become more apparent from the following detailed description of embodiments thereof taken in conjunction with the accompanying drawings in which:

FIG. 1A is a block diagram illustrating a system for ultrasonic inspection flaw screening according to an example embodiment of the present subject matter;

FIG. 1B shows different probe types according to an example embodiment of the present subject matter;

FIG. 1C shows a graphical representation of different types of scan data according to an example embodiment of the present subject matter;

FIG. 2A illustrates an example of a probe performing beam steering in a top view and an isometric view according to an example embodiment of the present subject matter;

FIG. 2B shows example B-scan images from different beams in a beam steering inspection according to an example embodiment of the present subject matter;

FIG. 3 illustrates a flow diagram for a method for performing inspection using beam steering inspection according to an example embodiment of the present subject matter;

FIG. 4 illustrates an example pictorial representation of beam skew configurations according to an example embodiment of the present subject matter;

FIG. 5 illustrates an example of a T-scan according to an example embodiment of the present subject matter;

FIG. 6 illustrates example of display layouts according to an example embodiment of the present subject matter; and

FIG. 7 illustrates an example of a display layout according to an example embodiment of the present subject matter.

### DETAILED DESCRIPTION

Phased array ultrasonic testing (PAUT) inspection data (e.g., indications) typically includes geometric echoes, which can complicate the search for genuine flaw echoes. In practice, inspection analysts face a challenging task that may include striking a balance in their performance. A trade-off may exist between inspection throughput and a thoroughness of inspection as performed by an individual analyst.

Techniques for beam performing PAUT with beam steering are described herein. Beam steering includes generating beams to interrogate the object in search for flaws where the beams are at projected at different angles from the probe and thus are able to detect flaws in different positions and orientations in the object. The techniques described herein can simplify the inspection process for the analyst (e.g., operator). For example, the techniques described herein can group a plurality of different beam skews in a single group as part of the same channel, leading to simpler handling and calibration. The techniques also describe a new scan image showing the different beam skews together so that the analyst can select and switch between the different beam skews easily. Thus, the techniques can allow the analyst to perform the inspection in a straightforward, simple manner. Accordingly, the techniques can provide savings in reducing the time involved for the inspection process and improve accuracy by reducing the chance of a missed or mischaracterized indications.

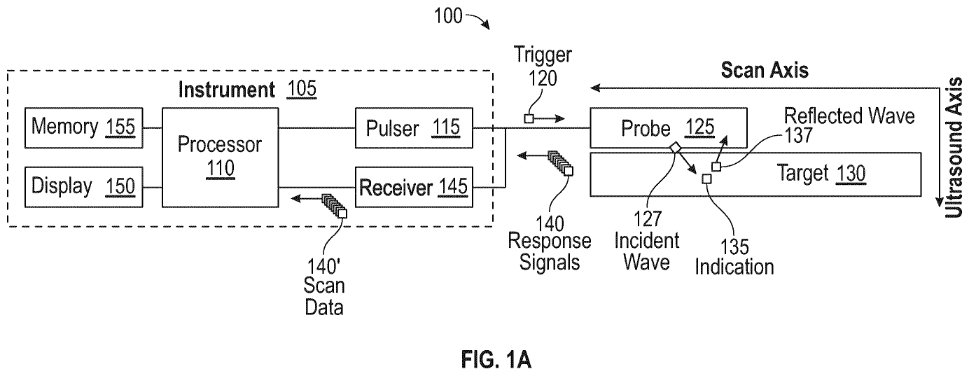

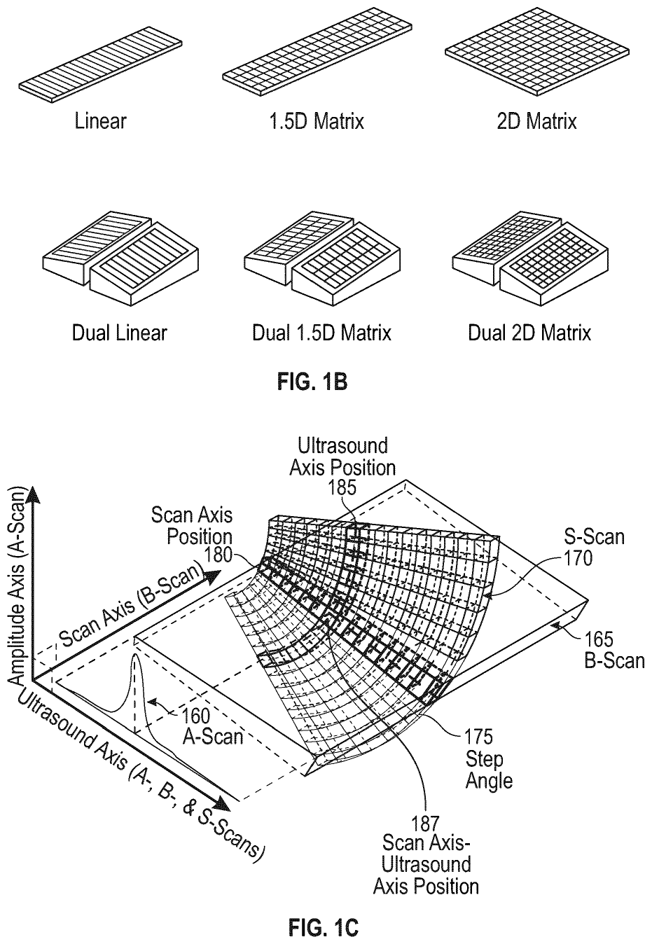

FIG. 1A is a block diagram illustrating a system 100 for ultrasonic inspection flaw screening according to an example embodiment of the present subject matter. The system 100 includes several functional units, such as a processor 110, a pulser 115, a receiver 145, a probe (e.g., transducer) 125, and a display device 150. As illustrated in FIG. 1A, the system 100 includes an instrument 105 having a processor 110, a pulser 115, a receiver 145, a display 150, and a memory 155. The pulser 115 can produce high voltage electrical pulses. Under control of the processor 110 and driven by a trigger 120 from the pulser 115, a probe (e.g., a transducer) 125 generates high frequency ultrasonic energy. The sound energy is introduced and propagates through a target 130 in the form of incident waves 127. When there is a discontinuity or other indication 135 (e.g., a crack) in the wave path, part of the energy will be reflected back from the flaw surface as a reflected wave 137. The reflected wave 137 is transformed by the probe 125 into an electrical response signal 140 and received by the receiver 145 which may convert the response signals 140 into scan data 140′ (e.g., A-Scan data and scan axis position data). The processor 110 then may receive the scan data 140′ for analysis. In some embodiments, the scan data 140′ is analyzed in real-time using the display 150 as it is received from the probe 125 and, in other embodiments, the scan data 140′ may be stored to memory 155 for either offline analysis using the instrument display 150 or an external computer (not shown).

FIG. 1B shows different probe types for probe 125. Linear probe includes a series of elements (e.g., carbon steel) distributed along a length, corresponding to an active axis of the probe. Matrix probes include elements arranged in both the active axis and a secondary axis of the probe. Delayed firing of the elements can be used to steer beams. Matrix probes can be provided in a rectangular arrangement (1.5D) where the number of rows and columns of elements are different or a square arrangement (2D) where the number of rows and columns of elements are equal. In a single probe configuration, the probe transmits the incident wave 127 and also receives the reflected wave 137. In a dual probe configuration, the transmission and reception are separated, where one probe transmits the incident wave 127 and another probe positioned also on the surface of the target 130 receives the reflected wave 137. A wedge structure may also be coupled to the bottom surface of the probes improve the acoustic propagation of the ultrasound waves. The wedge structure can include rigid thermoset polymer having known acoustic propagation characteristics (for example, Rexolite® available from C-Lec Plastics Inc.)

FIG. 1C shows a graphical representation of different types of scan data 140′. The scan data 140′ can include information for different scan axis positions 180 and ultrasound axis positions 185. Scan axis can refer to a common axis shared by the probe 125 and the target 130 (e.g., part being inspected) along the inspection path, e.g., the path the probe 125 traverses along the target 130. For example, for a weld inspection, the scan axis can be defined as an axis parallel to a long axis of a weld line, with the scan axis defining an inspection path for the probe. Ultrasound axis can refer to a propagation direction of the ultrasound wave (e.g., incident wave 127 and reflected wave 137 propagation, such as represented as rays extending toward or from an echogenic feature within the target 130 being inspected.

A-scan 160 can refer to amplitude values of the reflected wave (Amplitude Axis) along the ultrasound axis. B-Scan 165 can refer to the combined amplitude values (A-scan values) along the scan axis. S-scan 170 can refer to a sectorial scan of the amplitude values (A-scan values) along an ultrasound axis position for a sector at a given scan axis position. Other scans can be included, such as a C-scan, which can refer to the combined amplitude values of each beam along the scan axis.

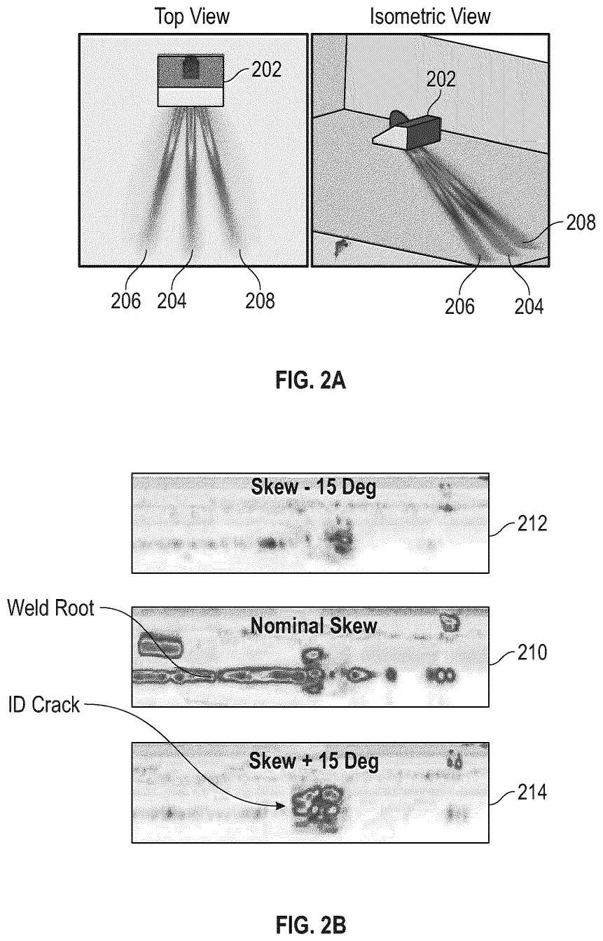

FIG. 2A illustrates an example of a probe performing beam steering in a top view and an isometric view. A probe 202 may generate a plurality of beams at different angles using delays in the active elements. For example, the probe 202 may generate a first beam 204 at a nominal angle, a second beam 206 at −15°, and a third beam 208 at +15°. FIG. 2B shows example B-scan images from the different beams. As shown, the B-scan images for the different angled beams can reveal different information about the target. Image 210 is a B-scan result corresponding to the first beam 204 at the nominal angle. Image 210 shows a weld root in the target. Image 212 is a B-scan result corresponding to the second beam 206 at −15°. Image 210 shows different characteristics of the target. Image 214 is a B-scan result corresponding to the third beam 208 at +15°. Image 214 shows different characteristics of the target. For example, misoriented defects (or defects oriented differently), such as a skewed ID crack, are better detected and sized with the third beam 208 at +15° as compared to the first beam 204 at the nominal angle.

In some conventional systems, the different beam skews are managed separately as their own individual skew group, also referred to as beam set. In these conventional systems, each beam skew is a separate channel and requires its own handling, simulation, and calibration. This can lead to numerous steps for an operator to perform. For example, the operator is required, in these conventional systems, to set up a separate channel for each beam skew angle and calibrate each channel separately.

The present subject matter includes a single group/beam set, which includes a plurality of different beam skew angles, each having a plurality of beam angles, which can simplify the preparation and management. A plurality of beam skews can be arranged in a same group, called a “3D sectorial scan” (also referred to as “3D compound scan”). The 3D sectorial scan can support regular sectorial scans as well as compound-S sectorial scans, which can further reduce the number of groups.

Also, calibration can be performed on one of the beam skew angles from the plurality of different beam skew angles in the group, and the calibration results for the one beam skew angle can be used for the other beam skew angles in the group. In other words, calibration for one beam skew angle or subset of beam skew angles in the group is performed as opposed to individual calibrations for each respective beam skew angle.

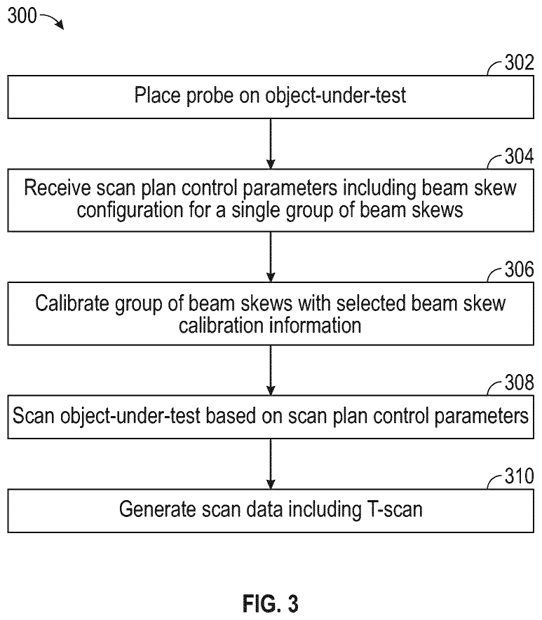

FIG. 3 illustrates a flow diagram for a method 300 for performing inspection using beam steering. At operation 302, a probe or a set of probes in a dual probe configuration, as described above, are placed on the object-under-test. At operation 304, scan plan control parameters are received from a user (e.g., technician, operator). The scan plan control parameters may include identification of primary axis elements, including a first element, a last element, and quantity of elements associated with the primary axis. The primary axis is associated with steering the beam angle. The scan plan control parameters may include identification of secondary axis elements, including a first element, a last element, and quantity of elements associated with the secondary axis. The secondary axis is associated with steering skew angles. The scan plan control parameters may include primary axis controls, such as angle start, angle stop, and angle step.

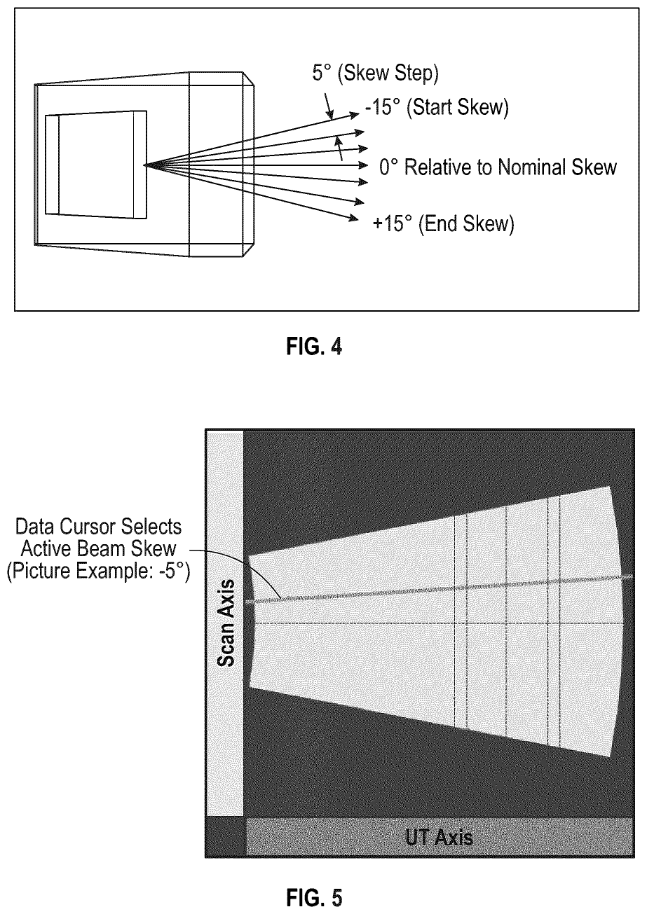

Relevant to beam skewing, the scan plan control parameters include beam skew configurations for the secondary axis, such as skew start, skew stop, and skew step. FIG. 4 illustrates an example pictorial representation of beam skew configurations. The skew start may represent an angle of the first beam skew relative to the nominal skew (0°). In the example of FIG. 4, skew start is set at −15°. The skew stop may represent an angle of the last beam skew relative to the nominal skew. In the example of FIG. 4, the skew stop is set to +15°. The skew step may represent the step size of the angles between the beam skews. In the example of FIG. 4, the skew step is set to 5°, so that a beam skew is at every 5° between the start and stop skew (e.g., −15°, −10°, −5°, 0°, +5°, +10°, +15°). These respective beam skews are arranged in a one group/beam set. That is, one channel is used for the different beam skews as they are part of the group/beam set. The single channel corresponds to a single group (beam set).

A plurality of active elements in the probe can be used to steer beam in different axes. This can be applicable to both primary axis and the secondary axis of the probe. For example, two or more elements in the primary axis can be used to steer angles, and two or more elements in the secondary axis can be used to steer beam skew. In this example, at least four elements (2×2) are used to steer in both the primary and secondary axis.

Returning to FIG. 3, at operation 306, calibration may be performed for the group of beam skews. The calibration may include determining time corrected gain (TCG) values for a selected beam skew angle from the group of beam skews. The TCG values for the select beam skew angle may be deployed for the other beam skew angles in the group of beam skews. That is, calibration for one beam skew can be used for the whole group of beam skews and individual calibration for each beam skew is not required. For example, TCG values may be calculated for the nominal beam skew and can be extrapolated to apply to the other beam skews in the group.

In some examples, more than one beam skew in the group (but less than total amount of beam skews in the group) may be calibrated. In these examples, interpolation can be used to provide calibration data for the other beam skews in the group.

At operation 308, scanning of the object-under-test is performed based on the scan control parameters. For example, the probe may generate incident waves based on the scan control parameters to penetrate the object-under-test. Reflected waves from indications in the object-under-test may be received by the probe. The reflected waves may be transformed into electrical response signals.

At operation 310, scan data may be generated based on the response signals. The scan data may include A-Scan, B-Scan, C-Scan, and S-Scan data, as described above. The scan data may also include a T-scan data associated with the beam skew results. T-scan can refer to a secondary axis sectorial scan (beam steering) of the amplitude values (A-scan values) along an ultrasound axis position for a sector at a given scan axis position. The T-scan displays a slice of data, not volume. The T-scan is relative to the probe, not the object-under-test. The T-scan represents each beam skew in 2D against a UT axis and Scan axis. In some examples, the nominal skew, which represents 0° beam skew, may be centered in the display.

S-scan and T-scan are similar in that they are representing amplitude from more than one beam against ultrasound axis, for a given scan axis position. However, the difference between S-scan and T-scan is that S-scan represents beams of different angles for a given beam skew, while T-scan represents beams of different beam skews for a given beam angle. Each PAUT beam fired in a 3D scan includes a unique set of refracted beam skew parameters. Consider an example: 30 refracted angles from a primary axis with 5 beam skews can be fired. That is, 30 (refracted angle beams)×5 (beam skews)=150 different beams produced. S-scan can show the 30 refracted beams for a given beam skew, while T-scan can show the 5 beam skews for a given refracted angle. Thus, the T-scan provides a different viewpoint and information than other scans.

FIG. 5 illustrates an example of a T-scan. As shown, the horizontal axis is the UT axis and the vertical axis is the scan axis. The scan axis can update with scan position. Each beam skew is represented in 2D. A data cursor can select the active beam skew. In example of FIG. 5, the −5° beam skew is selected. Weld overlay can be refreshed from the data cursor value (skew angle). The T-scan can display slice of data selected by the corresponding angle of the data cursor. The T-scan shows uncorrected technique of presenting different beam skews in a single display. As explained above, the T-scan can be 90° perpendicular to a S-Scan.

The different beam skews are grouped in a single group and therefore can be display in a single channel. Multiple scans can therefore be displayed together with the T-scan, allowing the operator to select a particular beam skew and changing other scan displays accordingly for the selected beam skew.

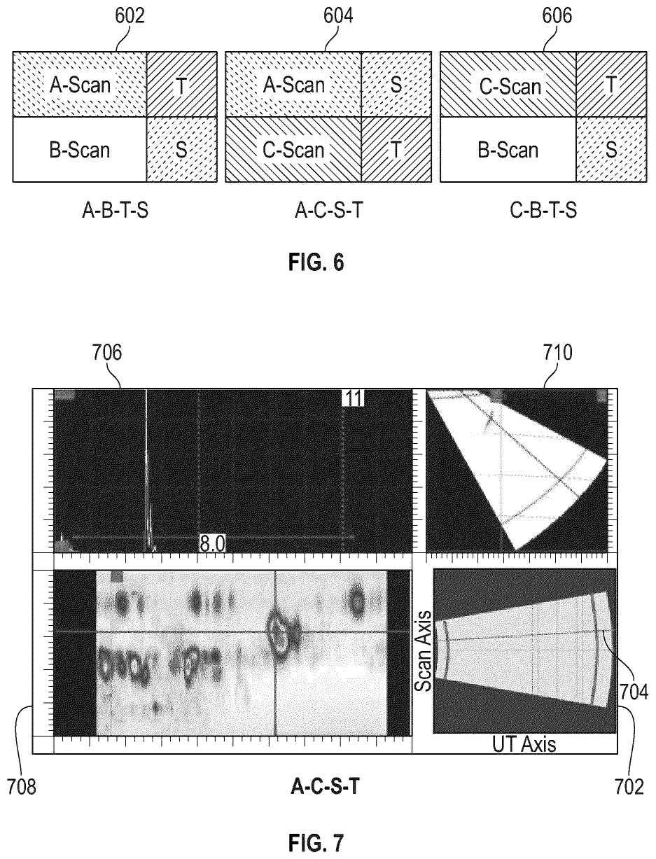

FIG. 6 illustrates example of display layouts. Display layout 602 includes sections for A-scan, B-scan, T-scan, and S-scan (A-B-T-S). Display layout 604 includes sections for A-scan, B-scan, S-scan, and T-scan (A-C-S-T). Display layout 606 includes sections for C-scan, B-scan, T-scan, and S-scan (C-B-T-S). As mentioned above, in response to a user selecting a particular beam skew in the T-Scan section, the information for the other scan sections may be changed or refreshed corresponding to the selected beam skew.

FIG. 7 illustrates an example of a display layout. The display layout includes sections for A-scan, B-scan, S-scan, and T-scan (A-C-S-T). Section 702 shows T-scan with a selected skewed beam 704 shown by the data cursor. Section 706 shows A-scan data corresponding to the selected skewed beam. Section 708 shows C-scan data corresponding to the selected skewed beam. Section 710 shows S-scan data.

Processing (e.g., executing one or more of the methods described herein) may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information. The memory may include a machine readable medium on which is stored one or more sets of data structures or instructions (e.g., software) embodying or utilized by any one or more of the techniques or functions described herein.

In some embodiments, the system may be embodied by one or more programmable processors executing one or more computer programs to perform the functions of the system. In some other embodiments, all or part of the system may be implemented as special purpose logic circuitry (e.g., a field-programmable gate array (FPGA) and/or an application-specific integrated circuit (ASIC)). In some other embodiments, all or part of the system may be implemented using electronic hardware circuitry that include electronic devices such as, for example, at least one of a processor, a memory, a programmable logic device or a logic gate.

In one embodiment, the methods described herein are not limited to the specific examples described. In a further embodiment, rather, any of the method steps may be re-ordered, combined or removed, or performed in parallel or in serial, as necessary, to achieve the results set forth above.

In some embodiments, the system may be implemented, at least in part, via a computer program product, (e.g., in a non-transitory machine-readable storage medium such as, for example, a non-transitory computer-readable medium), for execution by, or to control the operation of, data processing apparatus (e.g., a programmable processor, a computer, or multiple computers)). In certain embodiments, each such program may be implemented in a high level procedural or object-oriented programming language to communicate with a computer system. In certain other embodiments, however, the programs may be implemented in assembly or machine language. In some embodiments, the language may be a compiled or an interpreted language and it may be deployed in any form, including as a stand-alone program or as a module, component, subroutine, or other unit suitable for use in a computing environment. In some other embodiments, a computer program may be deployed to be executed on one computer or on multiple computers at one site or distributed across multiple sites and interconnected by a communication network.

The methods and apparatus of this disclosure may take the form, at least partially, of program code (i.e., instructions) embodied in tangible non-transitory media, such as floppy diskettes, CD-ROMs, hard drives, random access or read only-memory, or any other machine-readable storage medium. When the program code is loaded into and executed by a machine, such as the computer of FIG. 4, the machine becomes an apparatus for practicing examples of the present subject matter. When implemented on one or more general-purpose processors, the program code combines with such a processor to provide a unique apparatus that operates analogously to specific logic circuits. As such, a general purpose digital machine can be transformed into a special purpose digital machine. In some other embodiment, a non-transitory machine-readable medium may include but is not limited to a hard drive, compact disc, flash memory, non-volatile memory, volatile memory, magnetic diskette and so forth but does not include a transitory signal per se.

The term “machine readable medium” or “machine readable storage medium” may include any medium that is capable of storing, encoding, or carrying instructions for execution by a machine and that cause the machine to perform any one or more of the techniques of the present disclosure, or that is capable of storing, encoding or carrying data structures used by or associated with such instructions. Non-limiting machine-readable medium examples may include solid-state memories, and optical and magnetic media. Accordingly, machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic or other phase-change or state-change memory circuits; magnetic disks, such as internal hard disks and removable disks; magneto-optical disks; and CD-ROM and DVD-ROM disks.

Although the foregoing examples have been described in some detail for purposes of clarity of understanding, it will be apparent that certain changes and modifications may be practiced within the scope of the appended claims. The scope of the invention is limited only by the claims and the invention encompasses numerous alternatives, modifications, and equivalents. Numerous specific details are set forth in the above description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured. Accordingly, the above implementations are to be considered as illustrative and not restrictive, and the invention is not to be limited to the details given herein, but may be modified within the scope and equivalents of the appended claims.

Various embodiments of the present disclosure have been described with reference to the accompanying drawings. It may be appreciated that these example embodiments are provided only for enabling those skilled in the art to better understand and then further implement the present disclosure and not intended to limit the scope of the present disclosure in any manner. It should be noted that these drawings and description are only presented as examples of embodiments and, based on this description, alternative embodiments may be conceived that may have a structure and method disclosed as herein, and such alternative embodiments may be used without departing from the principle of the disclosure as claimed in the present disclosure.

It may be noted that the flowcharts and block diagrams in the figures may illustrate the apparatus, method, as well as architecture, functions and operations executable by a computer program product according to various embodiments of the present disclosure. In this regard, each block in the flowcharts or block diagrams may represent a module, a program segment, or a part of code, which may contain one or more executable instructions for performing specified logic functions. It should be further noted that, in some alternative implementations, functions indicated in blocks may occur in an order differing from the order as illustrated in the figures. For example, two blocks shown consecutively may be performed in parallel substantially or in an inverse order sometimes, which depends on the functions involved. It should be further noted that each block and a combination of blocks in the block diagrams or flowcharts may be implemented by a dedicated, hardware-based system for performing specified functions or operations or by a combination of dedicated hardware and computer instructions.

The terms “comprise(s),” “include(s)”, their derivatives, and like expressions used herein should be understood to be open (i.e., “comprising/including, but not limited to”). The term “based on” means “at least in part based on”, the term “one embodiment” means “at least one embodiment”, and the term “another embodiment” indicates “at least one further embodiment”. Relevant definitions of other terms have been provided.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other implementations can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed implementation. Thus, the following claims are hereby incorporated into the Detailed Description as examples or implementations, with each claim standing on its own as a separate implementation, and it is contemplated that such implementations can be combined with each other in various combinations or permutations. The scope of the invention should be determined with reference to the appended claims, along with the full scope of equivalents to which such claims are entitled

What is claimed is:

1. A method of ultrasonic inspection with different beam skews, the method comprising:
receiving scan control parameters including beam skew configuration for a plurality of beam skews arranged in a group;
performing calibration for a for a respective beam skew the plurality of beam skews;
establishing calibration values for at least one other beam skew of the plurality of beam skews based on the calibration performed for the respective beam skew;
receiving data indicative of electrical response signals elicited by scanning the object, the scanning based on the scan control parameters; and
generating data for a presentation based on the data indicative of electrical response signals corresponding to the plurality of beam skews in a channel.

2. The method of claim 1, further comprising:
generating a scan image showing the group of the plurality of beam skews.

3. The method of claim 2, wherein the scan image includes a horizontal axis corresponding to an ultrasonic testing axis and a vertical axis corresponding to a scan axis.

4. The method of claim 2, wherein the scan image represents each of the plurality of beam skews of the group in two dimensions.

5. The method of claim 4, further comprising:
receiving a selection an active beam skew based on the scan image.

6. The method of claim 5, further comprising:
refreshing the scan data to display slice of data corresponding to the selected active beam skew.

7. The method of claim 6, wherein the display includes a layout with multiple scans associated with the selected active beam skew.

8. A system comprising:
one or more processors of a machine; and
a memory storing instructions that, when executed by the one or more processors, cause the machine to perform operations comprising:
receiving scan control parameters including beam skew configuration for a plurality of beam skews arranged in a group;
performing calibration for a for a respective beam skew the plurality of beam skews;
establishing calibration values for at least one other beam skew of the plurality of beam skews based on the calibration performed for the respective beam skew;
receiving data indicative of electrical response signals elicited by scanning the object, the scanning based on the scan control parameters; and
generating data for a presentation based on the data indicative of electrical response signals corresponding to the plurality of beam skews in a channel.

9. The system of claim 8, the operations further comprising:
generating a scan image showing the group of the plurality of beam skews.

10. The system of claim 9, wherein the scan image includes a horizontal axis corresponding to an ultrasonic testing axis and a vertical axis corresponding to a scan axis.

11. The system of claim 9, wherein the scan image represents each of the plurality of beam skews of the group in two dimensions.

12. The system of claim 11, the operations further comprising:
receiving a selection an active beam skew based on the scan image.

13. The system of claim 12, the operations further comprising:
refreshing the scan data to display slice of data corresponding to the selected active beam skew.

14. The system of claim 13, the operations wherein the display includes a layout with multiple scans associated with the selected active beam skew.

15. A machine readable storage medium that, when executed by a machine, cause the machine to perform operations comprising:
receiving scan control parameters including beam skew configuration for a plurality of beam skews arranged in a group;
performing calibration for a for a respective beam skew the plurality of beam skews;
establishing calibration values for at least one other beam skew of the plurality of beam skews based on the calibration performed for the respective beam skew;
receiving data indicative of electrical response signals elicited by scanning the object, the scanning based on the scan control parameters; and
generating data for a presentation based on the data indicative of electrical response signals corresponding to the plurality of beam skews in a channel.

16. The machine readable storage medium of claim 15, further comprising:
generating a scan image showing the group of the plurality of beam skews.

17. The machine readable storage medium of claim 16, wherein the scan image includes a horizontal axis corresponding to an ultrasonic testing axis and a vertical axis corresponding to a scan axis.

18. The machine readable storage medium of claim 16, wherein the scan image represents each of the plurality of beam skews of the group in two dimensions.

19. The machine readable storage medium of claim 18, further comprising:
receiving a selection an active beam skew based on the scan image.

20. The machine readable storage medium of claim 19, further comprising:
refreshing the scan data to display slice of data corresponding to the selected active beam skew.
